(19) United States
(12) Patent Application Publication
(10) Pub. No.: US 2007/0201836 A1
(43) Pub. Date: Aug. 30, 2007

(54) Hard disc recorder

(75) Inventors: Hirono Tsubota, Daito-shi (JP); Yasuo Masaki, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/702,508

(22) Filed: Feb. 6, 2007

(30) Foreign Application Priority Data
Feb. 7, 2006 (JP) 2006-029716

(51) Int. Cl. H04N 7/00

(52) U.S. Cl. 386/96

(57) ABSTRACT

In a hard disc recorder (1) which transits to sleep mode so as to reduce electric power consumption when it is not used by a user in a predetermined term, an imaging unit (9) takes images in an imaging area in front of the hard disc recorder (1) at a predetermined time interval. A person detection unit (32) detects and identifies a person who stays in the imaging area by performing facial recognition process. A transition setting unit (34) sets an individual transition time for the identified user on the basis of a time when the user is detected and a database of execution history of recording or reproducing operation instructed by the user, and set a basic transition time on the basis of a database of execution history of recording or reproducing operation instructed by all users. When the individual transition time comes or when the basic transition time comes in the sleep mode, a hard disc drive controller (31) transits the operation mode of the hard disc recorder (1) from the sleep mode to standby mode where a hard disc recorder (2) is recordable or reproducible.

### BACKGROUND OF THE INVENTION

1. Field of the Invention

The present invention relates to a hard disc recorder which records audio and visual signals such as television (TV) broadcast signals into a hard disc drive as digital data, reads out the digital data from the hard disc drive and outputs the digital data to an external display apparatus.

2. Description of the Related Art

In recent years, a hard disc recorder on which a hard disc drive is mounted is widely used as a recording/reproducing apparatus for receiving, recording and reproducing TV broadcast programs. The hard disc recorder records the TV broadcast signals into the hard disc drive as digital data, reads out the digital data from the hard disc drive and outputs the digital data to an external display apparatus.

In such a hard disc recorder, when the recording or reproducing function is not performed in a predetermined term, the hard disc recorder generally takes a sleep mode where the hard disc drive is stopped so as to reduce power consumption by the hard disc drive. When the recording or reproducing function is performed in the sleep mode or start time of reserved recording is approached, the hard disc drive is started to be rotated. After the rotation of a recording disc of the hard disc drive becomes stable, the hard disc recorder becomes recordable or reproducible.

In the conventional hard disc recorder, it takes several seconds to transit from the sleep mode to standby mode where the hard disc recorder is recordable or reproducible, so that the usability of the conventional hard disc recorder is deteriorated a little. Specifically, even when a user wishes to record a TV program which the user views at the time, the hard disc recorder in the sleep mode wastes a time to start the actual recording of the TV program from the recording operation, so that a part of the TV program is not recorded in the recording disc. Alternatively, when the TV program which is already recorded in the recording disc is reproduced or erased, the hard disc recorder in the sleep mode wastes a time to start the actual reproducing of the TV program from the reproducing operation or to complete the erasure of the TV program from the erasing operation.

Japanese Laid-Open Patent Publication No. 2000-123460 discloses a conventional recording and reproducing apparatus that uses a commercial electric power as a power source in a time zone having high possibility that the user uses the apparatus and switches a battery as the power source in a time zone having lower possibility that the user uses the apparatus in the sleep mode of the apparatus. This apparatus can reduce the power consumption due to the circuit in the sleep mode by switching the power source between the commercial electric power and the battery. The time zone having high possibility that the user uses the apparatus is automatically set by memorizing times to start or to stop the recording or reproducing operation of the apparatus or by detecting time zones where the user stays in the room. In the time zone having high possibility that the user uses the apparatus in the sleep mode, although predetermined functions such as reception of contracted information or timer display which the user needs are activated while the power switch of the apparatus is turned off with saving the power consumption in the sleep mode, the recording disc of the hard disc drive is not rotated stable so as to be recordable or reproducible. Thus, even when the user operates the apparatus to recode or to reproduce the TV program, the TV program is not recorded or reproduced shortly.

Japanese Laid-Open Patent Publication No. 2000-188728 discloses a video display apparatus that supplies electric power to a module for taking data in a time period previously programmed by a user so that electric power consumption in the sleep mode can be reduced.

Japanese Laid-Open Patent Publication No. 2001-84662 discloses a video player that detects whether a user stays in a viewable area or not in audio and video reproducing mode, and pauses the reproducing when the user is not stayed in the area.

Japanese Laid-Open Patent Publication No. 5-183856 discloses a recording and reproducing apparatus such as a VTR (Video Tape Recorder) that enables to set an inoperable time from the sleep mode to the standby mode by a user.

Japanese Laid-Open Patent Publication No. 8-9282 discloses a display apparatus that recognizes a person who operates the apparatus or judges whether a user stays in a viewable area or not by operation of a remote controller, an infrared ray sensor or image process with using a camera, and controls brightness of a screen or volume of sounds with using the recognition information.

The above-mentioned conventional recording and reproducing apparatus, however, cannot solve the problem that the apparatus in the sleep mode wastes a time to transit to the standby mode where the hard disc recorder is recordable or reproducible.

### SUMMARY OF THE INVENTION

A purpose of the present invention is to provide a hard disc recorder which enables to transit from the sleep mode to the standby mode where it is recordable or reproducible shortly when recording or reproducing operation is selected by a user in the sleep mode so that usability of the hard disc recorder is improved.

A hard disc recorder in accordance with an aspect of the present invention records digital audio and video signals into a hard disc drive, reproduces the digital audio and video signals from the hard disc drive, and outputs the digital audio and video signals to an external monitor display apparatus. The hard disc recorder comprises a hard disc drive control means that transits operation mode of the hard disc recorder from sleep mode where rotation of a recording disc of the hard disc drive is stopped so as to reduce electric power consumption to standby mode where the recording disc is rotated stably so as to enable recording of the digital audio and video signals into the hard disc drive or reproducing of the digital audio and video signals from the hard disc drive at predetermined transition time.

According to such a configuration, when the predetermined transition time comes, the operation mode of the hard disc recorder is transited to the standby mode where the recording disc of the hard disc drive is rotated stably, so that the recording or reproducing operation can be performed soon when instructed by the user.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a block diagram showing an example of a hard disk recorder in accordance with an embodiment of the present invention;

FIG. 2 is a flowchart showing an example of operations of the above hard disk recorder;

FIG. 3 is a flowchart showing a database forming process and an installation process of a time to transit from sleep mode to standby mode where the hard disc recorder is recordable or reproducible; and

FIG. 4 is a chart showing an example of the database formed by a database forming unit of the above hard disc recorder.

### DETAILED DESCRIPTION OF THE EMBODIMENT

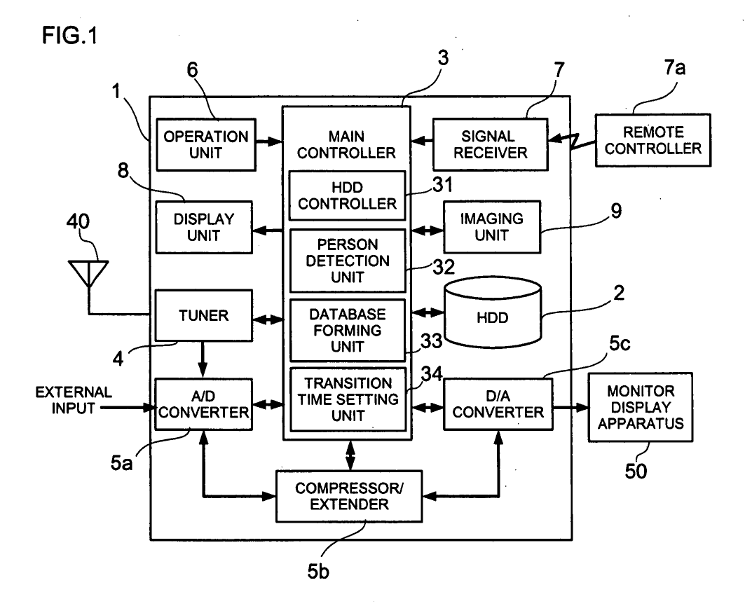

A hard disc recorder in accordance with an embodiment of the present invention is described with reference to the figures. FIG. 1 shows a block configuration of the hard disk recorder in accordance with this embodiment.

The hard disk recorder 1 comprises a hard disc drive 2 inside, and has recording and reproducing functions. In the recording function, the hard disc recorder 1 performs recording operation with receiving audio and visual signals such as TV broadcast signals inputted through an antenna 40 and recording the received signals as digital data into the hard disc drive 2. In the reproducing function, the hard disc recorder 1 performs reproducing operation with reading the digital data recorded in the hard disc drive 2 and outputting the read data to an external apparatus.

The hard disc recorder 1 is generally used in a state where a monitor display apparatus 50 such as an LCD (Liquid Crystal Display) apparatus, which displays an image on a monitor screen with using visual signals, is connected to output terminals (not shown), so that a user can view images of TV programs which are recorded in the hard disc recorder 1.

The hard disc recorder 1 further comprises a tuner 4 that receives analogue or digital TV broadcast signals of a desired channel among TV broadcast signals which are delivered from a plurality of TV stations and inputted through the external antenna 40, and outputs video signals (including audio signals and visual signals). The analogue video signals outputted from the tuner 4 or video signals inputted from external AV (Audio and Visual) apparatus through external input terminals (not shown) are converted to digital signals by an A/D (Analogue to Digital) converter 5a. The digital signals converted by the A/D converter 5a or directly inputted from the tuner 4 or the external AV apparatus are further encoded and compressed by a compressor/extender 5b so as to be recorded into the hard disc drive 2 as digital data. When the digital data recorded in the hard disc drive 2 are read out, the compressor/extender 5b decodes the encoded and compressed digital signals to reproduce the original digital signals. When the monitor display apparatus 50 is compatible with only analogue signals, the decoded digital signals are converted to analogue signals by a D/A (Digital to Analogue) converter 5c, and outputted to the monitor display apparatus 50 through the output terminals. Alternatively, when the monitor display apparatus 50 is compatible with digital signals, the decoded digital signals are directly outputted to the monitor display apparatus 50 through the output terminals.

An operation unit 6, which is operated by a user, for example, to select a channel of a TV program to be received, to input instruction to start recording or reproducing the TV program and to input a preset time to start recording the TV program, is provided on a front panel of the hard disc recorder 1. A remote control signal receiver 7 receives infrared ray signals from a remote controller 7a, for example, to select the channel to be received and so on and converts electric signals corresponding to the instruction by the user. A display unit 8, which is configured by an LCD or LEDs (Light Emitting Diodes) are further provided, for example, on the front panel of the hard disc recorder 1 so that substance of the instruction selected by the user, operation mode of the hard disc recorder 1, current time, and so on can be displayed. The hard disc recorder 1 still further comprises an imaging unit 9 including an imaging device such as CMOS (Complementary Metal Oxide Semiconductor),inside of the front panel so that an image of a predetermined area in front of the front panel of the hard disc recorder 1 can be taken. A main controller 3 controls entire of the hard disc recorder 1. The hard disc recorder 1 is driven with supplying external commercial electric power.

The hard disc drive 2 comprises at least one set of a recording disc into which digital data are recorded and a recording and reading head-which is provided on a swing arm and through which the digital data are recorded into or read out from the recording disc. While the recording disc is rotated in a predetermined rotation speed stably, the recording and reading head moves above the recording disc with a predetermined gap so that digital data are magnetically recorded into or read out from the recording disc.

The main controller 3 comprises a CPU (Central Processing Unit) that executes predetermined programs so as to control each part of the hard disc recorder 1, a RAM (Random Access Memory) that is used as a work memory of the CPU, a ROM (Read Only Memory) that stores the predetermined programs and so on, and a timer. The predetermined programs include control programs for performing recording and reproducing function of digital data on and from the hard disc drive 2, for performing preset recording, and for performing automatic mode transition of the hard disc recorder 1 (details of which are described later).

The main controller 3 further serves as a hard disc drive (HDD) controller (hard disc drive control means) 31 that controls to star and to stop the rotation of the recording disc of the hard disc drive 2, a person detection unit (person detection means) 32, a database forming unit (database forming means) 33 and a transition time setting unit (transition time setting means) 34.

When the main controller 3 receives a predetermined signal such as recording start signal or reproducing start signal from the operation unit 6 or the remote controller 7a, or when the preset time for starting recording comes, the main controller 3 executes the control program of recording or reproducing digital data of TV program into or from the hard disc drive 2 corresponding to the substance of the signal or the preset recording.

Subsequently, an example of the operation of the hard disc recorder 1 is described. When the hard disc recorder 1 has a state that both of the operation unit 6 and the remote controller 7a are not operated by the user and the preset recording or reproducing is not performed more that fifteen minutes, the main controller 3 stops the rotation of the recording disc of the hard disc drive 2 and transits the operation mode of the hard disc recorder 1 to the sleep mode so as to reduce the electric power consumption. When the operation unit 6 or the remote controller 7a is operated by the user or the preset time to start recording comes, the main controller 3 starts to rotate the recording disc of the hard disc drive 2 in a predetermined rotation speed, so that the operation mode of the hard disc recorder 1 transits to the standby mode where the hard disc drive 2 is recordable or reproducible. The stop and start of rotation of the hard disc drive 2 is performed by the hard disc drive controller 31 of the main controller 3. Then, the main controller 3 accesses the hard disc drive 2 corresponding to the substance of the operation by the user or the preset recording so that the digital data are recorded into or readout from the hard disc drive 2.

For example, when the recording operation is performed, after transiting the operation mode of the hard disc recorder 1 to the standby mode from the sleep mode, the main controller 3 controls the A/D converter 5a to convert the analogue TV broadcast signals received by the tuner to digital signals, the compressor/extender 5b to compress the digital signals, and the hard disc drive 2 to record the compressed digital signals into the recording disc as digital data. At this time, the main controller 3 records the digital signals to be recorded with information of the TV program and so on into the hard disc drive 2 as a picture recording file. In addition, a file information database including information of the picture recording files recorded by the above recording operation is recorded into the hard disc drive 2, so that the file information database can be used to search the picture recording file to be reproduced, or to display a list of titles and recording time of the picture recording files on a monitor screen of the monitor display apparatus 50.

On the other hand, when the reproducing operation is performed, after transiting the operation mode of the hard disc recorder 1 to the standby mode from the sleep mode, the main controller 3 controls the hard disc drive 2 to read out the digital data of the picture recording file from the recording disc, the compressor/extender 5b to decode the digital signals of the read digital data and the D/A converter 5c to convert the decoded digital signals to analogue audio and video signals and to output the audio and video signals to the monitor display apparatus 50 through the output terminals. Thereby, images of the recorded TV program are reproduced on the monitor screen of the monitor display apparatus 50 and sounds are outputted from speakers, so that the user can view the TV program.

In addition, move or erase of the picture recording file recorded in the hard disc drive 2 can be performed by operating the operation unit 6 or the remote controller 7a. For performing such move or erase of the picture recording file, the main controller 3 accesses the hard disc drive 2 after transiting the operation mode of the hard disc recorder 1 to the standby mode from the sleep mode.

By the way, the hard disk recorder 1 has the above mentioned automatic mode transition function that transit the operation mode of the hard disc recorder 1 to the standby mode where the hard disc drive 2 becomes recordable or reproducible when it becomes on a preset time from the sleep mode. The automatic mode transition function is described in detail.

In this embodiment, the automatic mode transition function is performed by the main controller 3 serving as the hard disc drive controller 31, the person detection unit 32, the database forming unit 33 and the transition time setting unit 34. The person detection unit 32 detects a user in an image taken from the imaging unit 9 by processing the image, and identifies the user by performing, for example, the facial recognition. The database forming unit 32 forms a database of execution history of the recording and reproducing operation including information relating to start and stop time of the recording and reproducing operation by the user. The database of this execution history is recorded into the hard disc drive 2. The storage facility of the database, however, is not limited to the hard disc drive 2, so that it may be stored in a nonvolatile memory such as a flash memory. The transition time setting unit 34 sets a transition time when the operation mode of the hard disc recorder 1 is transited to the standby mode from the sleep mode by the hard disc drive controller 31 on the basis of the database formed by the database forming unit 33. In this embodiment, the transition time includes a basic transition time which is automatically set on the basis of the execution history of the recording and reproducing operations and individual transition times for a plurality of users which are set corresponding to the users individually.

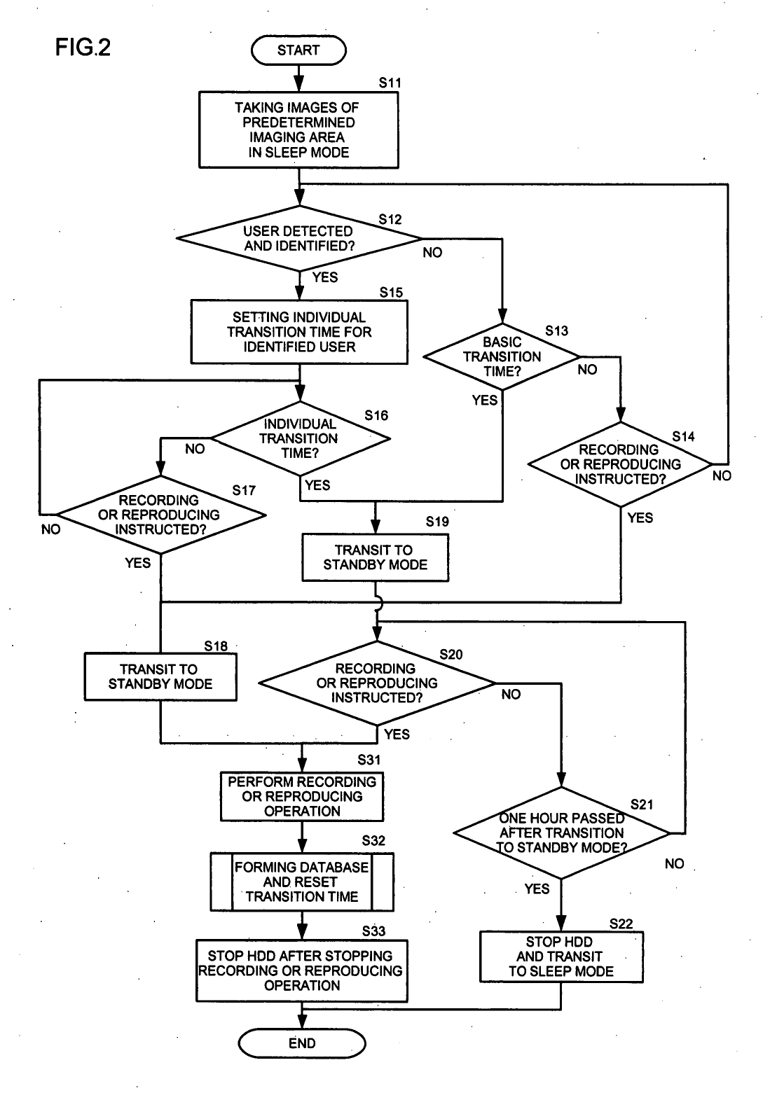

FIG. 2 shows flows of the operation of the hard disc recorder 1. When the hard disk recorder 1 is in the sleep mode, the imaging unit 9 takes an image of a predetermined imaging area in front of the front panel of the hard disk recorder 1 (S11). This imaging process by the imaging unit 9 is performed at a predetermined time interval, for example, once in each one second. Then, the person detection unit 32 judges whether a user stays in the imaging area more than a predetermined time, for example, one minutes or not by performing the image recognition process to the image data taken by the imaging unit 9. Since the person detection unit 32 waits the predetermined tome after detecting the user, it is possible to distinguish the user staying in the imaging area from a passenger. When it is judged that the user stays in the imaging area, the user is further identified by performing the facial recognition (S12). When it is judged that no user stays in the imaging area or when it is judged that a user stays in the imaging area but the user cannot be identified (NO in step S12), the hard disc drive controller 31 further judges whether the basic transition time comes or not (S13). In this embodiment, the basic transition time is set corresponding to holiday or weekday, so that this judgment is performed in consideration of the day of the week. Alternatively, when the basic transition time has not come yet (NO in step S13) and when no recording or reproducing operation is instructed by the user (NO in step S14), the main controller 3 repeats the above mentioned flows until the basic transition time comes.

On the other hand, when the detected user is identified (YES in step S12), the main controller 3 sets the individual transition time for the identified user which is a time passing a predetermined individual waiting time with respect to the identified user after the time when the user is detected or identified (S15). For example, when the identified user is a child, he or she may operate the operation unit 6 or the remote controller 7a soon to instruct to start the recording or reproducing TV program. Alternatively, when the identified user is an adult, he or she may not operate the operation unit 6 or the remote controller 7a soon. Thus, the individual waiting time for each user may be different each other.

When the individual transition time for the identified user is set, the hard disc drive controller 31 judges whether the independent transition time comes or not (S16). When the individual transition time has not come yet (NO in step S16) and when no recording operation or reproducing operation is instructed by the user (NO in step S17), the hard disc drive controller 31 waits until the individual transition time comes. Then, when the recording operation or the reproducing operation is instructed by the user while the basic transition time or the individual transition time has not come yet (YES in step S14 or S17), the hard disc drive controller 31 transits the operation mode of the hard disc recorder 1 to the standby mode (S18), and the main controller 3 performs the recording operation or the reproducing operation corresponding to the instruction by the user (S31).

Hereupon, when the basic transition time comes (YES in step S13) or when the individual transition tome comes in the sleep mode (YES in step S16), the hard disc drive controller 31 transits the operation mode of the hard disc recorder 1 to the standby mode although the user instructs no recording operation or reproducing operation or the reserved time for recording has not come yet (S19). When the recording operation or the reproducing operation is instructed in the standby mode (YES in step S20), the main controller 3 performs the recording operation or the reproducing operation corresponding to the instruction by the user (S31).

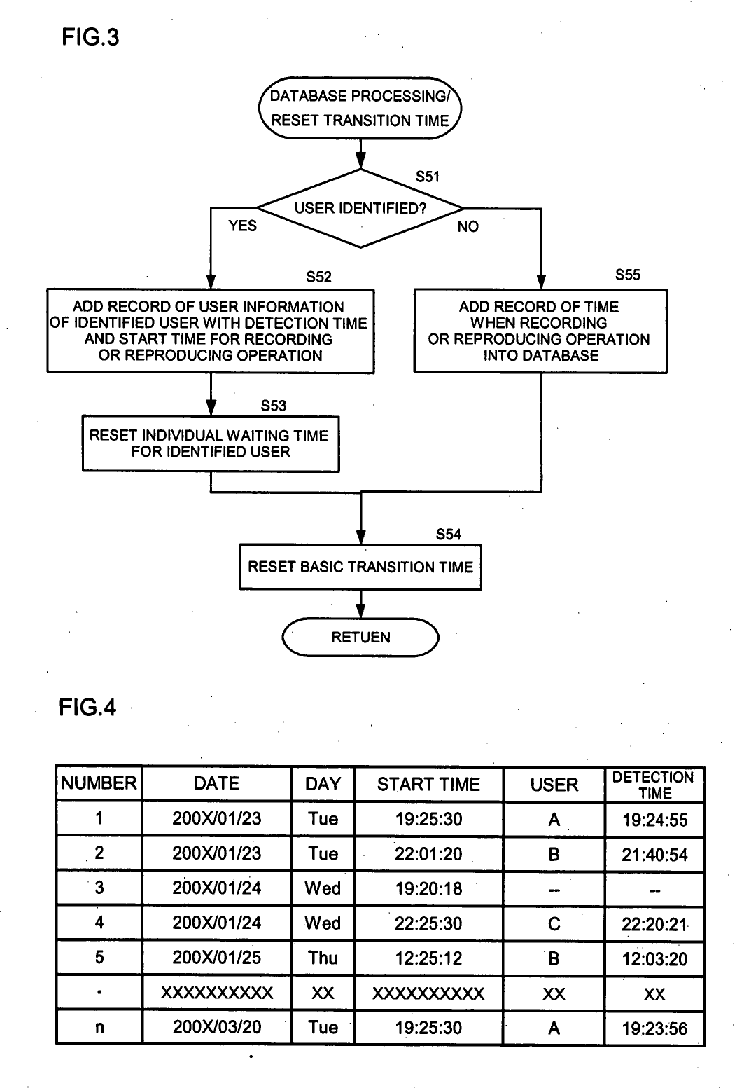

In this embodiment, when the recording or reproducing operation is performed (S31), the database forming unit 33 forms or renews the database of the execution history of the recording or reproducing operation, and the transition time setting unit 34 resets the transition time (S32). FIG. 3 shows flows of these processes. FIG. 4 shows an example of the database formed by the database forming unit 33. The processes of forming or renewing the database and resetting of the transition time when the user is identified are different from those when the user is not detected or detected but not identified.

The processes of forming or renewing the database and resetting of the transition time are described with reference to FIG. 3. When the user is identified (YES in step S51), the database forming unit 33 forms and adds a record in the database, where user information showing the identified user and the detection time of the user are correlated with the start time when the recording or reproducing operation is performed (S52). As shown in FIG. 4, the user information of the identified user is, for example, inputted into the record of the database with assigning inherent code such as A, B, C, . . . in order of detection according to each user who was identified by the person detection unit 32. Thereby, it is possible to distinguish the records for the identified user from the records for other users. In other words, the databases are formed with respect to each users identified by the person detection unit 32. In addition, in this embodiment, the start time when the recording or reproducing operation is performed is inputted into the record with the information of the date and the day of the week.

After forming or renewing the database, the transition time setting unit 34 resets the .individual waiting time for the identified user on the basis of the information for the identified user and the database newly formed or renewed (S53). In this embodiment, the individual waiting time is set by the following steps. First, the records with respect to the identified user are extracted from the database. Subsequently, a time period from the detection time of the user to the start time of recording or reproducing is calculated with respect to each record, and a mean value of the above time periods for the records is calculated. Then, the individual waiting time is set to be a time shorter by a predetermined time, for example, five minutes than the mean value of the time periods.

As shown in FIG. 4, when the user A who may be a child is identified, since the mean value of the time periods from the detection time of the user to the start time of the recording or reproducing is about 90 seconds, the individual wait time for the user A is set to be zero second. In other words, when the user A will be identified next, the individual transition time for the user A is set just in the detection time when the user A will be identified.

Similarly, when the user B who may be an adult is identified, since the mean value of the above time periods is about 40 minutes, the individual wait time for the user B is set to be 35 minutes. When the user B will be identified next, the individual transition time for the user B is set in a time after passing 35 minutes from the detection time when the user B will be identified, so that the sleep mode is maintained about 35 minutes after identification of the user B.

After resetting the individual waiting time, the transition time setting unit 34 resets the basic transition time (S54). The basic transition time is set for each day of the week on the basis of all records in the database. The steps for resetting the basic transition time are different from those for the individual transition time. In this embodiment, a frequency that the recording or reproducing operations are performed is calculated in each time zone of, for example, 10 minutes in a day in a period, for example, 100 days where the records of the database are recorded. Then, the start time of a time zone where the frequency is equal to or larger than, for example, 25% is set to be the basic transition time. For example, when the time zones from 19:20 to 19:30 and from 22:20 to 22:30 show the frequencies equal to or higher than 25%, both of 19:20 and 22:20 are set as the basic transition time. Hereupon, the basic transition time for weekdays from Monday to Friday and the basic transition time for holidays such as Saturday, Sunday and national holidays may be set individually with calculating the frequencies individually.

On the other hand, when no user is detected or when a user is detected but not identified (NO in step S51), the database forming unit 33 stores the record of the time when the recording or reproducing operation is performed into the database with the information of the date and the day in the week (S55). Then, the transition time setting unit 34 resets the basic transition time (S54).

When the execution history of the recording or reproducing operation is compiled into the database, the database forming unit 33 maintains only the records relating to the execution history for 100 days at the largest as the database, and erases the records of more than 100 days ago. Therefore, the capacity of the memory for the database can be prevented from enlargement. Furthermore, it is possible to set the basic transition time and the individual transition times corresponding to recent tendency of behavior of the user. Since the time period for maintaining the database is not limited to this example, all the records from the start to form the database may be maintained. In such a case, the transition time may be reset on the basis of only the records in a predetermined time periods in the database.

After performing the database forming or renewing process and resetting the transition time, when the recording or reproducing operation is completed, the hard disc drive controller 31 stops the rotation of the recording disc of the hard disc drive 2 when a predetermined time, for example, 15 minutes has passed from the stopping of the recording or reproducing operation so that the operation mode of the hard disc recorder 1 transits to the sleep mode (S33).

After transiting the operation mode of the hard disc recorder 1 to the standby mode when the basic transition time or the individual transition time comes in the sleep mode (S19), and when the recording or reproducing operation has not been performed (NO in step S20), and when a predetermined time, for example, an hour has passed from the transition to the standby mode (YES in step S21), the hard disc drive controller 31 stops the rotation of the recording disc of the hard disc drive 2 so that the operation mode of the hard disc recorder 1 transits from the standby mode to the sleep mode again (S22).

In this way, when the basic transition time or the individual transition time, which is set on the basis of the execution history of the recording or reproducing operation instructed by the user or users, comes in the sleep mode of the hard disc recorder 1, the operation mode of the hard disc recorder 1 automatically transits from the sleep mode to the standby mode where the hard disc recorder is recordable or reproducible. Thus, when the user instructs the recording or reproducing operation, the hard disc recorder 1 almost always has been in the standby mode where the hard disc recorder 2 is recordable or reproducible. Consequently, the hard disk recorder 1 becomes convenient to recordable or reproducible depending on the operation by the user, immediately.

Furthermore, the person detection unit 32 can identify a user who stays in front of the hard disc recorder 1 among a plurality of users with using the images taken by the imaging unit 9, so that the individual transition time can be set for each user corresponding to the individual waiting time for each user. Thus, it is possible to transit the operation mode of the hard disc recorder 1 from the sleep mode to the standby mode corresponding to the tendency of the behavior of the identified user who actually operates the optical disc recorder 1. Consequently, the hard disc recorder 1 becomes convenient much more with reducing the electric power consumption.

Still furthermore, the basic transition time can be switched corresponding to, for example, weekday and holiday, so that the basic transition time can be set appropriately even when the time zone where the user instructs the recording or reproducing of the TV program is varied corresponding to the day in the week.

Still furthermore, when the recording or reproducing operation has not been instructed in a predetermined time period, for example, one hour after transition of the operation mode of the hard disc recorder 1 to the standby mode from the sleep mode, the hard disc drive controller 31 stops the rotation of the recording disc of the hard disc drive 2 so as to transit the operation mode of the hard disc recorder 1 from the standby mode to the sleep mode again. Therefore, it is possible to reduce the electric power consumption of the hard disc recorder 1 while the convenience of the hard disc recorder 1 is maintained.

The present invention is not limited to the configuration of the above mentioned embodiment, and can be modified in various manners in the scope where the sprit of the invention is not changed. For example, the basic transition time, and the individual transition time and/or the individual waiting time for each user can be set by the user or users optionally.

Furthermore, the imaging unit 9 and the person detection unit 32 are not necessarily provided in the hard disc recorder 1. The basic transition time may be set on the basis of the database of the operation history by the user or on the basis of detection time information that shows a time when any user is detected in the predetermined area in front of the hard disc recorder 1 without identifying the user.

Still furthermore, it is possible not to transit the operation mode of the hard disc recorder 1 to the standby mode when no user is detected or when any user is detected but not identified, even when the basic transition time comes. In such a case, when the user who stays in the predetermined area in front of the hard disc recorder 1 is detected or identified by the imaging unit 9 and the person detection unit 32, the hard disc drive controller 3 may rotates the recording disc of the hard disc drive 2 immediately so as to transit the operation mode of the hard disc recorder 1 to the standby mode from the sleep mode. According to such a configuration, the operation mode of the hard disc recorder 1 can be transit to the standby mode when the user instructs the recording or reproducing operation, so that the recording or reproducing of the TV program can be started soon.

In addition, the configuration of the hard disk recorder 1 in accordance with the present invention is not limited to the above mentioned embodiment. For example, it may be configured that the video signals are converted to the digital signals without compression and directly recorded into the hard disc drive 2 in the recording operation. Alternatively, it may be configured that the digital TV broadcast signals are receives and the received digital signals are directly recorded into the hard disc drive 2.

In summary, the hard disc recorder in accordance with the present invention comprises at least a hard disc drive control unit that transits operation mode of the hard disc recorder from sleep mode where rotation of a recording disc of the hard disc drive is stopped so as to reduce electric power consumption to, standby mode where the recording disc is rotated stably so as to enable recording of the digital audio and video signals into the hard disc drive or reproducing of the digital audio and video signals from the hard disc drive at predetermined transition time.

In the above mentioned constitution, it is preferable that the hard disc recorder further comprises a transition time setting unit that sets the transition time automatically on the basis of execution history of recording or reproducing operation of the digital audio and video signals instructed by a user or users.

Furthermore, it is preferable that the hard disc recorder further comprises a database forming unit that forms a database of the execution history of recording or reproducing the digital audio and video signals, and a transition time setting unit that sets the transition time on the basis of the database.

Alternatively, it is preferable that the hard disc recorder further comprises a person detection unit that detects and identifies a person who stays in a predetermined area in front of the hard disc recorder, and a transition time setting unit that sets an individual transition time for the user identified by the person detection unit on the basis of a time when the user is detected and execution history of recording or reproducing operation of the digital audio and video signals instructed by the user.

Furthermore, it is preferable that the person detection unit includes an imaging unit that takes an image of a predetermined area in front of a front panel of the hard disc recorder at a predetermined time interval, and the person detection unit identifies the user by performing facial recognition process.

Still furthermore, it is preferable that the transition time setting unit sets a time passing a predetermined individual waiting time from the time when the user is detected as the individual transition time, and the hard disc drive control unit transits the operation mode of the hard disc recorder to the standby mode at the individual transition time.

Alternatively, it is preferable that the hard disc recorder further comprises a person detection unit that detects and identifies a user who stays in a predetermined area in front of the hard disc recorder, a database forming unit that forms a database for each user identified by the person detection unit correlating with a time when the user is detected and execution history of recording or reproducing operation by the user, and a transition time setting unit that sets an individual transition time for the user identified by the person detection unit on the basis of information that the user is identified and the database for the user.

Furthermore, it is preferable that the person detection unit includes an imaging unit that takes an image of a predetermined area in front of a front panel of the hard disc recorder at a predetermined time interval, and the person detection unit identifies the user by performing facial recognition process.

Still furthermore, it is preferable that a plurality of transition times are set corresponding to day of the week.

Still furthermore, it is preferable that the hard disc drive control unit transits the operation mode of the hard disc recorder from the standby mode to the sleep mode when a predetermined time period has passed with no recording or reproducing operation instructed by the user after transiting the operation mode from the sleep mode to the standby mode.

This application is based on Japanese patent application 2006-029716 filed Feb. 7, 2006 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. A hard disc recorder, which records digital audio and video signals into a hard disc drive, reproduces the digital audio and video signals from the hard disc drive, and outputs the digital audio and video signals to an external monitor display apparatus, comprising:
a hard disc drive control means that transits operation mode of the hard disc recorder from sleep mode where rotation of a recording disc of the hard disc drive is stopped so as to reduce electric power consumption to standby mode where the recording disc is rotated stably so as to enable recording of the digital audio and video signals into the hard disc drive or reproducing of the digital audio and video signals from the hard disc drive at predetermined transition time.

2. The hard disc recorder in accordance with claim 1 further comprising a transition time setting means that sets the transition time automatically on the basis of execution history of recording or reproducing operation of the digital audio and video signals instructed by a user or users.

3. The hard disc recorder in accordance with claim 2 further comprising:
a database forming means that forms a database of the execution history of recording or reproducing the digital audio and video signals; and
a transition time setting means that sets the transition time on the basis of the database.

4. The hard disc recorder in accordance with claim 1 further comprising:
a person detection means that detects and identifies a person who stays in a predetermined area in front of the hard disc recorder; and
a transition time setting means that sets an individual transition time for the user identified by the person detection means on the basis of a time when the user is detected and execution history of recording or reproducing operation of the digital audio and video signals instructed by the user.

5. The hard disc recorder in accordance with claim 4, wherein
the person detection means includes an imaging unit that takes an image of a predetermined area in front of a front panel of the hard disc recorder at a predetermined time interval; and
the person detection means identifies the user by performing facial recognition process.

6. The hard disc, recorder in accordance with claim 5, wherein
the transition time setting means sets a time passing a predetermined individual waiting time from the time when the user is detected as the individual transition time; and
the hard disc drive control means transits the operation mode of the hard disc recorder to the standby mode at the individual transition time.

7. The hard disc recorder in accordance with claim 1 further comprising:
a person detection means that detects and identifies a user who stays in a predetermined area in front of the hard disc recorder;
a database forming means that forms a database for each user identified by the person detection means correlating with a time when the user is detected and execution history of recording or reproducing operation by the user; and
a transition time setting means that sets an individual transition time for the user identified by the person detection means on the basis of information that the user is identified and the database for the user.

8. The hard disc recorder in accordance with claim 7, wherein
the person detection means includes an imaging unit that takes an image of a predetermined area in front of a front panel of the hard disc recorder at a predetermined time interval; and
the person detection means identifies the user by performing facial recognition process.

9. The hard disc recorder in accordance with claim 1, wherein aplurality of transition times are set corresponding to day of the week.

10. The hard disc recorder in accordance with claim 1, wherein
the hard disc drive control means transits the operation mode of the hard disc recorder from the standby mode to the sleep mode when a predetermined time period has passed with no recording or reproducing operation instructed by the user after transiting the operation mode from the sleep mode to the standby mode.

11. A hard disc recorder comprising:
a hard disc drive having a recording disc into which digital data are recorded and a recording and reading head through which digital data are recorded into or read out from the recording head;
a tuner that receives television broadcast signals delivered from a television station and extracts analogue or digital television broadcast signals of a desired channel among television broadcast signals of a plurality of television stations which are inputted through an external antenna, and outputs video signals including audio signals and visual signals;
an A/D (Analogue to Digital) converter that converts the video signals outputted from the tuner or video signals inputted from external audio and visual apparatus through external input terminals to digital signals;
a compressor/extender that encodes and compresses the digital signals converted by the A/D converter so as to be recorded into the hard disc drive as digital data, and decodes the digital data read out from the hard disc drive to reproduce the original digital signals;
a D/A (Digital to Analogue) converter that converts the decoded digital signals to analogue signals, and outputs the analogue signals to an external monitor display apparatus through output terminals;
an operation unit provided on a front panel of the hard disc recorder and a remote controller, which are operated by a user to select a channel of a television program to be received, to instruct to start recording or reproducing the television program, or to set a preset time to start recording the television program;
a remote control signal receiver that receives infrared ray signals from the remote controller and converts electric signals corresponding to instruction by the user;
a display unit provided on the front panel of the hard disc recorder so as to display at least substance of the instruction by the user, operation mode of the hard disc recorder and current time;
an imaging unit including an imaging device inside of the front panel that takes an image of a predetermined imaging area in front of the front panel of the hard disc recorder;
a person detection units that judges whether a user stays in the imaging area or not and identifies the user when it judges that the user stays in the imaging area by performing facial recognition to the images taken by the imaging unit;
a database forming units that forms or renews a database of execution history of recording or reproducing operation by the user or users identified by the person detection unit with correlating a detection time when the user is detected with a start time for performing the recording or reproducing operation;
a transition time setting units that sets a basic transition time on the basis of the database corresponding to weekday and holiday and an individual transition time foe each user on the basis of user information showing the user identified by the user detection unit and the database; and
a hard disc drive controller that controls to star and to stop rotation of the recording disc of the hard disc drive, and to transit operation mode of the hard disc recorder to standby mode where the recording disc of the hard disc drive rotates in a predetermined rotation speed stably so that the hard disc drive is recordable or reproducible from sleep mode where the recording disc of the hard disc drive stops, when no user is detected in the imaging area or a user is detected in the imaging area but not identified and the basic transition time comes, or when a user is identified by the person detection unit and the individual transition time for the identified user comes.

12. The hard disc recorder in accordance with claim 11, wherein
the hard disc drive controller transits the operation mode of the hard disc recorder from the standby mode to the sleep mode when a predetermined time period has passed with no recording or reproducing operation instructed by the user after transiting the operation mode from the sleep mode to the standby mode.

13. The hard disc recorder in accordance with claim 11, wherein a plurality of transition times are set corresponding to day of the week.
